(19) United States
(12) Patent Application Publication
(10) Pub. No.: US 2014/0130556 A1
(43) Pub. Date: May 15, 2014

(54) Two-keyed anti-destructive clutch lock core

(71) Applicants: Pingjun Qi, (US); Xuhao Qi, (US)

(72) Inventors: Pingjun Qi, (US); Xuhao Qi, (US)

(21) Appl. No.: 13/676,218

(22) Filed: Nov. 14, 2012

(51) Int. Cl. E05B 35/12

(52) U.S. Cl. 70/339

(57) ABSTRACT

A lock core includes a rotation mechanism and a clutch mechanism for separating the unlocking and opening processes of locks and prevents the lock from being unlocked destructively. The rotation mechanism comprises a plug and a plug sleeve. The clutch mechanism comprises a group of discs and a sidebar. The rotation mechanism is triggered by the clutch mechanism. Therefore the primary key for the clutch mechanism locks/unlocks the rotation mechanism. A secondary key is introduced for turning the rotation mechanism to open the lock core. The primary key and the secondary key are combined by another mechanism comprises two slots, two rivets and a spring.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the Invention

The present invention relates to lock cores, and more particularly to a lock core that reduces the risk of being opened illegally through picking, smashing or other destructive unlocking methods.

2. Description of the Prior Arts

Locks are designed to protect properties from any unauthorized access. Thus the reliability of a lock becomes crucial. So far the most widely used lock core is still mechanical lock cores. A mechanical lock core, whether it is a pin-tumbler lock or a disc-tumbler lock, can only be opened by rotating the inserted key. However, in most burglaries mechanical locks are unlocked easily by destructive unlocking methods. Therefore the main challenge for such locks is how to prevent the lock from being unlocked destructively.

### SUMMARY OF THE INVENTION

The present invention provides an improved lock core that overcomes the foresaid drawback. In order to fulfill the purpose, firstly a non-rotatable master key slot, a rotatable secondary key slot and a protective panel are introduced to separate the unlocking (inserting the key allowing the discs to be aligned) and the opening (rotating the plug) processes to protect the lock from being opened through picking, smashing or other violence unlocking methods. Secondly, the use of multiple discs (more than five) grouping reduces the chance of duplicating keys. Also, the anti-picking slot built within the lock core prevents the lock from being picking. Thirdly the lock housing is made more protective than other detached locks (in which the plug is detached and can be rotated in locked position). In addition, the primary key and the secondary key are combined to one while not in use so that they are also convenient to carry and use.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is an illustration of the appearance of the lock core according to the present invention.

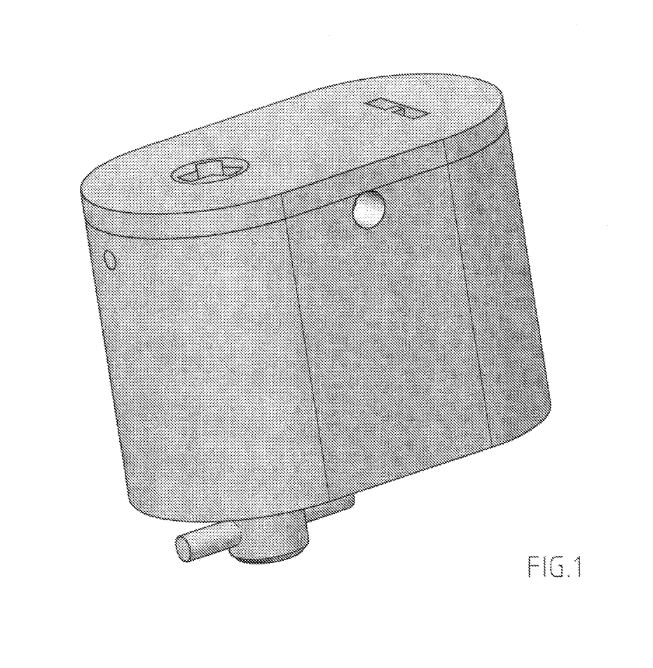

FIG. 2 is a structural illustration of the lock core according to the present invention in the locked position.

FIG. 3 is a structural illustration of the lock core according to the present invention in the unlocked position.

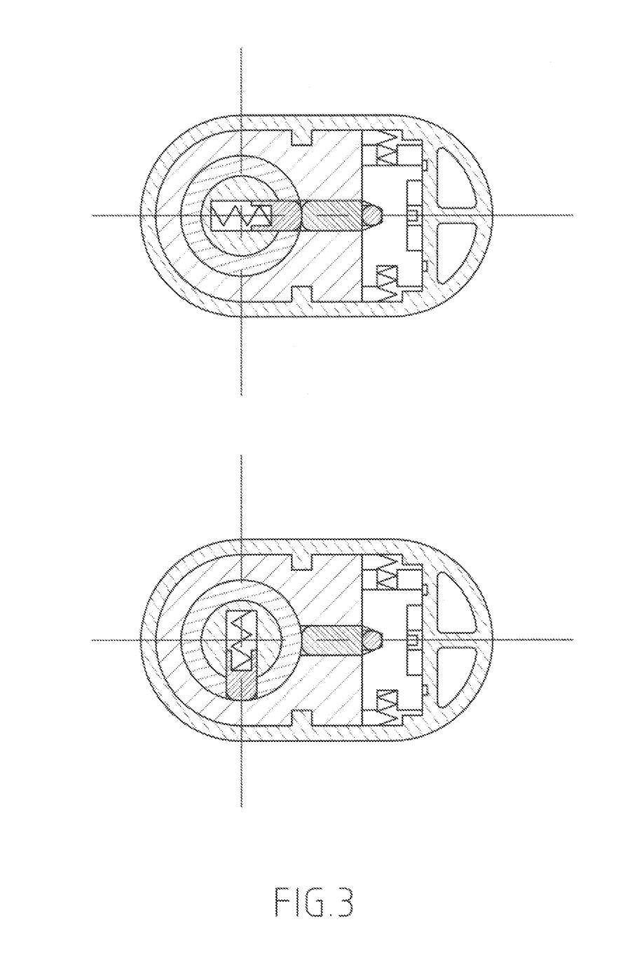

FIG. 4 is a structural illustration of the primary key and secondary key for the lock core.

FIG. 4 is an illustration of four different appearances of the protective panel on the lock core for different use.

### DETAILED DESCRIPTION OF THE INVENTION

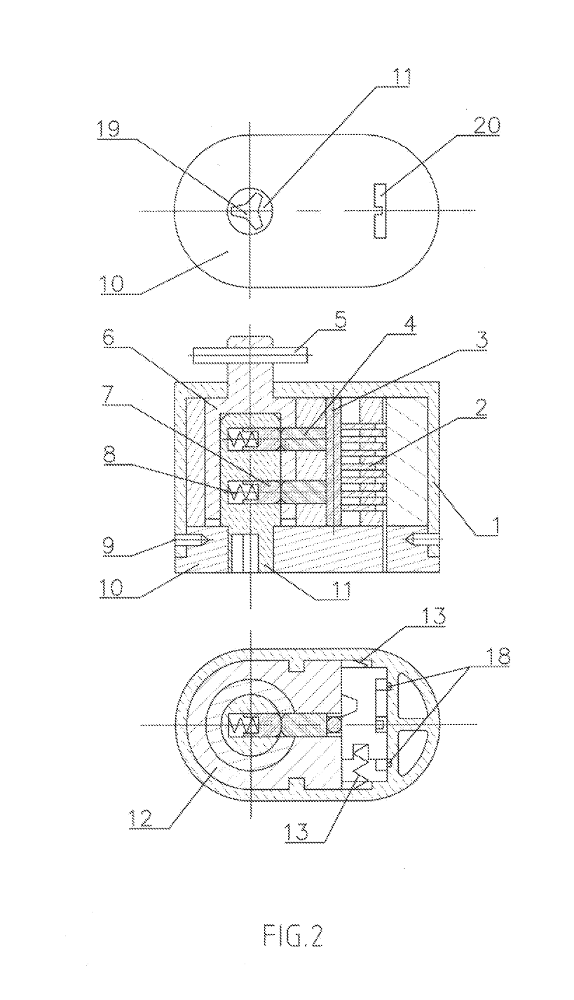

Referring initially to FIG. 2, where the discs 2 placed within the lock housing 1 are a group of slotted discs. A sidebar 3 placed on the left of the discs 2 can be pushed into these aligned slots. Two horizontally movable driver pins 4 are placed inside two passages on the left of the sidebar 3 to block the rotation of the plug sleeve 6. Two key pins 7 built within the plug 11 loaded by two springs 8 can be pushed into the plug sleeve 6 and thus engage the plug 11 with the plug sleeve 6. A bolt 5 driven by the plug sleeve 6 connects the lock core with any external applications. Two rivets engage the lock housing 1 with the protective panel 10. The protective panel 10 protects the interior parts of the lock core. Two keyholes are prepared on the protective panel 10 in which one is the primary key hole 20 and the other is the secondary key hole 19. The plug 11 rotates either by itself (in locked condition) or with the plug sleeve (when the correct primary key is inserted). The frame 12 fixes the position of all interior components. The spring 13 is built behind every disc and is used to restore the corresponding disc when the primary key 16 is removed. Two anti-picking slots 18 are used to prevent the lock core from being picked.

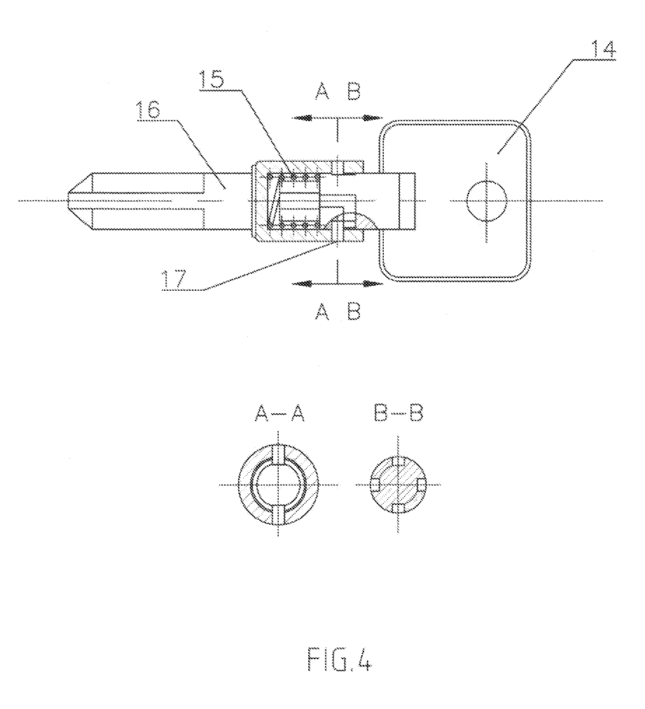

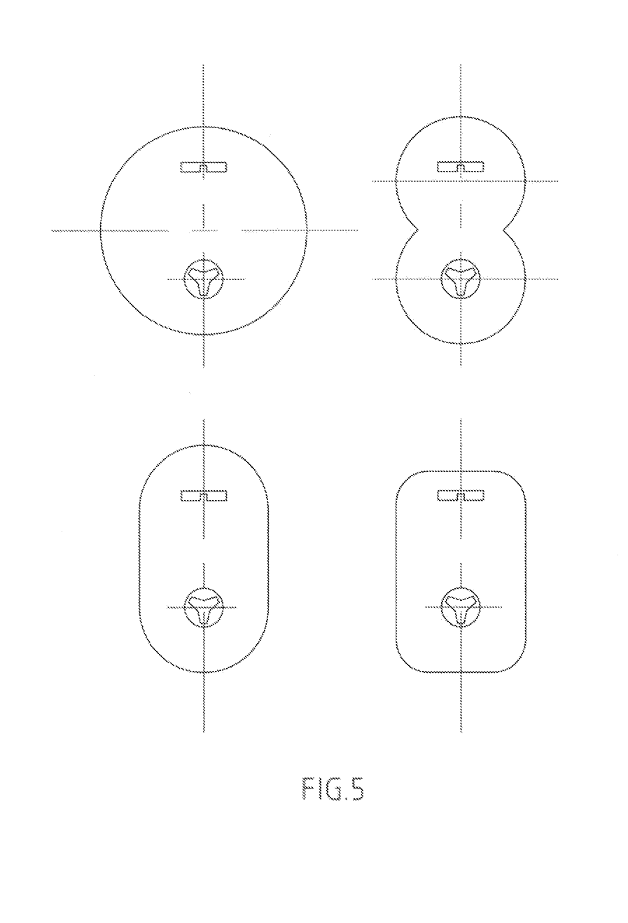

Referring to FIG. 4, the secondary key 14 features a shape that fits into the secondary keyhole 19 on plug 11 in FIG. 2. Two slots are cut on the secondary key 14 allowing the two rivets 17 on the primary key 16 to slide in. A spring 15 is placed inside the primary key 16 to prop the secondary key preventing the two rivets 17 from dropping out of the slots.

In the locked position, when the primary key 16 is not inserted, discs 2 are restored by their corresponding spring 13 such that the slots on discs 2 fail to align causing the sidebar 3 to be kept out of the slots. The two driver pins 4 placed next to the sidebar 3 is also retained in a position in which half of the pin stays inside the plug sleeve 6 while another half stays inside the frame 12. The rotation of the plug sleeve 6 is therefore disabled by the two driver pins 4. The two key pins 7 are blocked by the two driver pins 4 and become in line with the “shear line” of the plug 11 and the plug sleeve 6, allowing the plug 11 to rotate freely inside the plug sleeve 6 and the lock core to be locked.

When unlocking the device, firstly insert the primary key 16 into the primary keyhole 20. As the key slides into the keyway, the bits of the primary key 16 moves every disc 2 allowing the slots to be aligned. The two springs 8 then pushes the two key pins 7, the two driver pins 4 and the sidebar 3 to the right resulting the sidebar 3 to drop into the aligned slots on the discs 2. As the two driver pins 4 being pushed completely into frame 12, the two key pins 7 become in line with a new “shear line” of the plug sleeve 6 and the frame 12, allowing the plug 11 to be engaged with the plug sleeve 6. Secondly use the secondary key 14 to rotate the plug sleeve 6 along with the plug 11 to unlock the lock core.

When locking the device, firstly turn the secondary key 14 to a position instructed on the protective panel to line up the key pins 7 with the driver pins 4. Secondly pull out the primary key 16 to complete the locking process. As the primary key 16 slides out of the keyway, the bits of the primary key 16 and the springs 13 restores every disc 2, allowing the slots to be restored. The bevel edges of every slot then push the sidebar 3 out to the left causing the driver pins 4 and the key pins 7 to be restored to original locked position and the lock core to be locked.

To apply the combined keys, firstly insert the combined keys into the primary keyhole 20. Secondly detach the secondary key 14 by pressing the rear of the combined keys and rotating for 90 degree anti-clockwise. To regroup the two keys, press the secondary key 14 into the rear of the primary key 16 and then rotate the secondary key 14 for 90 degrees clockwise.

What is claimed is:

1. A lock core to be placed in any lock and reduces the risk of being opened illegally through picking, smashing or other destructive unlocking methods comprising:
two keyholes that separate the unlocking (insert the key) and the opening procedures (rotate the key);
a plug rotatable by said secondary key and a plug sleeve locks or unlocks said lock core;
a group of horizontally movable discs placed parallel to each other inside said lock core;
a cylinder shaped sidebar placed beside said discs and can be pushed into said left slots when said discs are aligned by said primary key;
two horizontally movable driver pins placed inside two passages on the left and perpendicular to said sidebar;
two anti-picking slots placed inside said protective panel preventing the lock from being picked;
a relatively thick (more than 4 mm) protective panel featuring four different shapes: the ellipse, circular, rectangular and two crossed circles for meeting the requirement in different environments; and
a pair of keys comprises a primary key and a secondary key.

2. The lock core as claimed in claim 1, wherein two spring-loaded key pins are placed within said plug for engaging said plug with said plug sleeve. Two holes are cut on said plug sleeve so that said plug sleeve can either be detached from said plug when engaged with the frame by two driver pins or can be rotated with said plug when engaged with said plug by said two key pins. Said plug is freely rotatable within said plug sleeve when said two key pin are retained inside said plug.

3. The lock core as claimed in claim 1, wherein both long sides of said discs are slotted in which said slots on the left long side are used for storing the sidebar and said slots on the right long side form a keyway for said primary key. The position of said slots on each said discs are different.

4. The lock core as claimed in claim 1, wherein said sidebar can also be pushed out of said slots by the bevel edges on said slots when said primary key is pulled out and said discs are restored.

5. The lock core as claimed in claim 1, wherein when said sidebar is pushed out of said slots by said the bevel edges on said discs, said driver pins will be pushed into the holes within said plug sleeve allowing the plug sleeve to be engaged with said frame. Said driver pins also push said key pins back into said plug and thus detach said plug from said plug sleeve. When said right slots on said discs are aligned by said primary key, said springs will push said key pins out of said plug allowing said plug to be engaged with said plug sleeve. Said driver pins are then pushed out of said holes on said plug sleeve causing said sidebar to drop into said aligned left slots on said discs.

6. The lock core as claimed in claim 1, wherein said primary key has a circular socket on the rear in which a spring and two rivets are placed for engaging said secondary key. The two keys can be grouped in two steps. Firstly press the secondary key onto said circular socket on the rear of said primary key and secondly rotate said secondary key for 90 degrees clockwise. While rotating, said two rivets loaded by said spring within said socket slides into two corresponding “L” shaped slots on said secondary key allowing said secondary key to be secured on said primary key.
